(19) United States
(12) Patent Application Publication
(10) Pub. No.: US 2008/0098185 A1
(43) Pub. Date: Apr. 24, 2008

(54) Remote file system with efficient handling of uncommitted pages

(76) Inventors: Saleem Mohideen, Cupertino, CA (US); Peter Keilty, Nashua, NH (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/584,693

(22) Filed: Oct. 20, 2006

(51) Int. Cl. G06F 13/00

(52) U.S. Cl. 711/159

(57) ABSTRACT

One embodiment relates to a method of handling uncommitted pages in a remote file system. At least three lists are maintained at a client of the remote file system. Said at least three lists include a list of dirty pages, a list of uncommitted pages, and a list of clean pages. Other features and embodiments are also disclosed.

### BACKGROUND

1. Field of the Invention

The present application relates generally to computers, networking and data storage. More particularly, the present application relates to remote file systems.

2. Description of the Background Art

Remote file systems include network file system (NFS) and cluster file systems. Remote file systems may provide synchronous and/or asynchronous writes.

For synchronous writes, a server of the remote file system is required to write data (and file system metadata) synchronously to stable storage (typically, hard disk storage) prior to the server replying successfully to the client write request. Synchronous writes, unfortunately, often create a bottleneck at the server that slows performance of the remote file system.

Asynchronous writes may be utilized to avoid the above-mentioned synchronous write bottleneck. When a server of the remote file system receives an asynchronous write request, the server does not need to write the data to stable storage prior to replying successfully to the client. Instead, the server may reply successfully to the client when the data is still in volatile memory at the server. Subsequently, the client may verify that the previously sent data has reached stable storage by sending a commit request to the server. The server replies successfully to the commit request only after the relevant data has been committed to the stable storage.

It is desirable to improve performance of remote file systems. More particularly, it is desirable to improve performance of asynchronous writes in remote file systems.

### BRIEF DESCRIPTION OF THE DRAWINGS

FIG. 1 is schematic diagram depicting a networked system employing a client-server paradigm.

FIG. 2 is a schematic diagram depicting various components of a remote file system in accordance with an embodiment of the invention.

FIG. 3 is a flow chart depicting a first phase in which “dirty” pages are written to the remote file system in accordance with an embodiment of the invention.

FIG. 4 is a flow chart depicting a second phase in which pages are committed to stable data storage in accordance with an embodiment of the invention.

FIGS. 5A and 5B are flow charts depicting moving pages between lists after modification at a client computer in accordance with an embodiment of the invention.

FIG. 6 is a schematic diagram depicting linked lists of pages in accordance with an embodiment of the invention.

### DETAILED DESCRIPTION

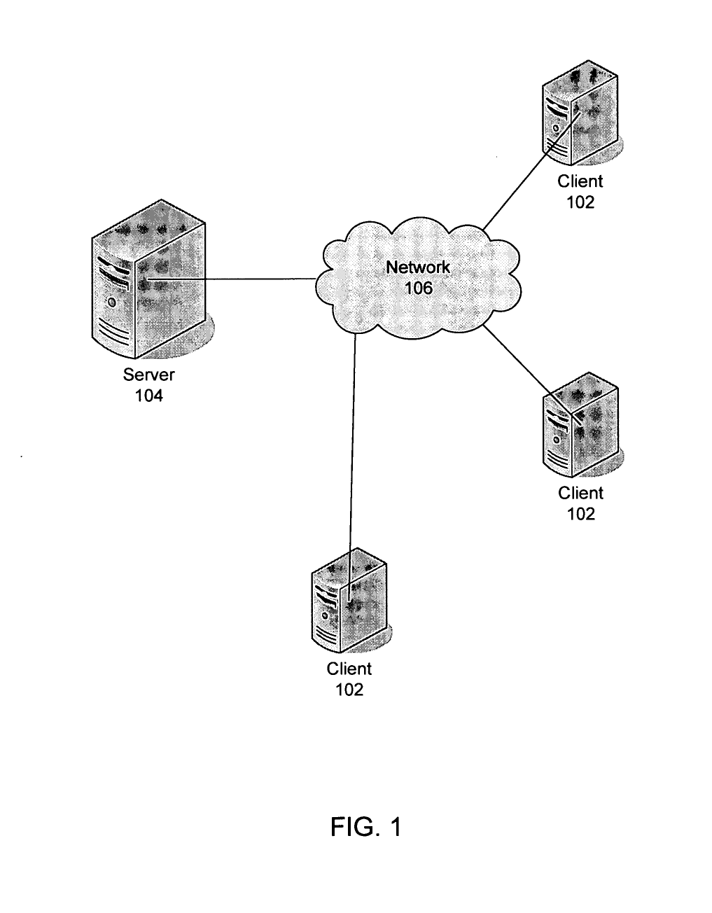

FIG. 1 is schematic diagram depicting a networked system employing a client-server paradigm. The system includes multiple node computers interconnected by a data network 106. In this example, the node computers shown include multiple clients 102 and a server 104.

Remote file systems employ such a client-server paradigm. A server of the remote file system is a computer that shares its file system with other computers on the network. A client of the remote file system is another computer on the network that may access the file system on the server. The client mounts the file system and subsequently may make file access requests over the network to the server.

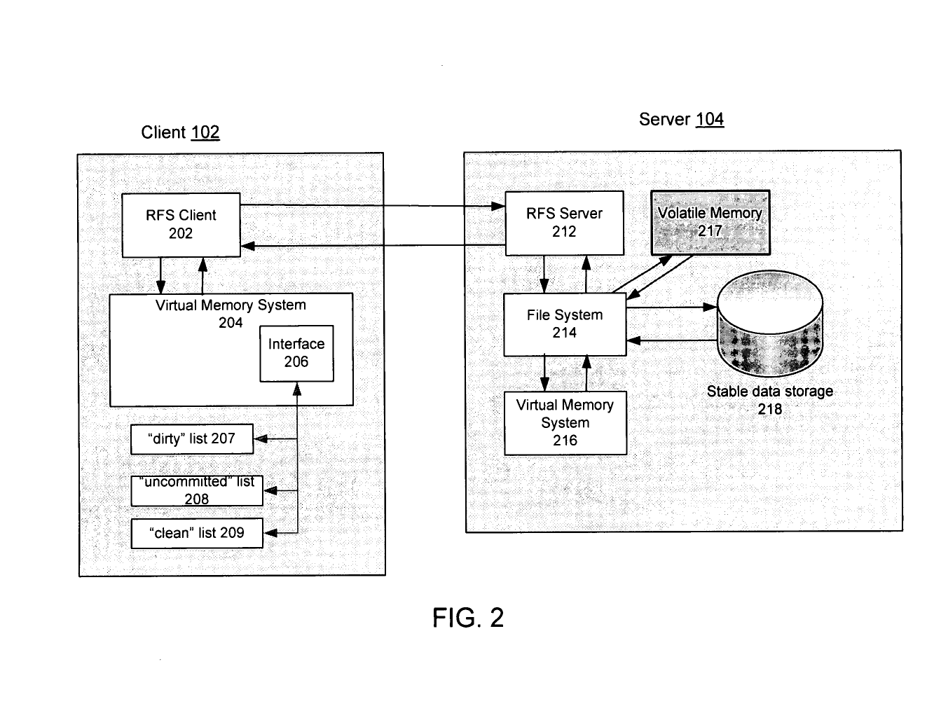

FIG. 2 is a schematic diagram depicting various components of a remote file system (RFS) in accordance with an embodiment of the invention. The remote file system may be a network file system (NFS), a cluster file system (CFS), or other remote file system. The diagram shows a client computer 102 and a server computer 104 which are interconnected via a network.

The client computer 102 includes at least an RFS Client 202, a virtual memory system (VMS) 204, an interface 206 in the VMS 204, and various page lists. The various page lists include at least a “dirty” list 207, an “uncommitted” list 208, and a “clean” list 209. The client computer 102 also includes various components which are not depicted, such as, for example, one or more processors, volatile memory, one or more communication buses, other operating system software components, application software, input/output, and so on.

The server computer 104 includes at least an RFS server 212, a file system 214, a virtual memory system 216, and stable data storage (typically, hard disk storage) 218. The server computer 104 also includes various components which are not depicted, such as, for example, one or more processors, volatile memory, one or more communication buses, other operating system software components, application software, input/output, and so on.

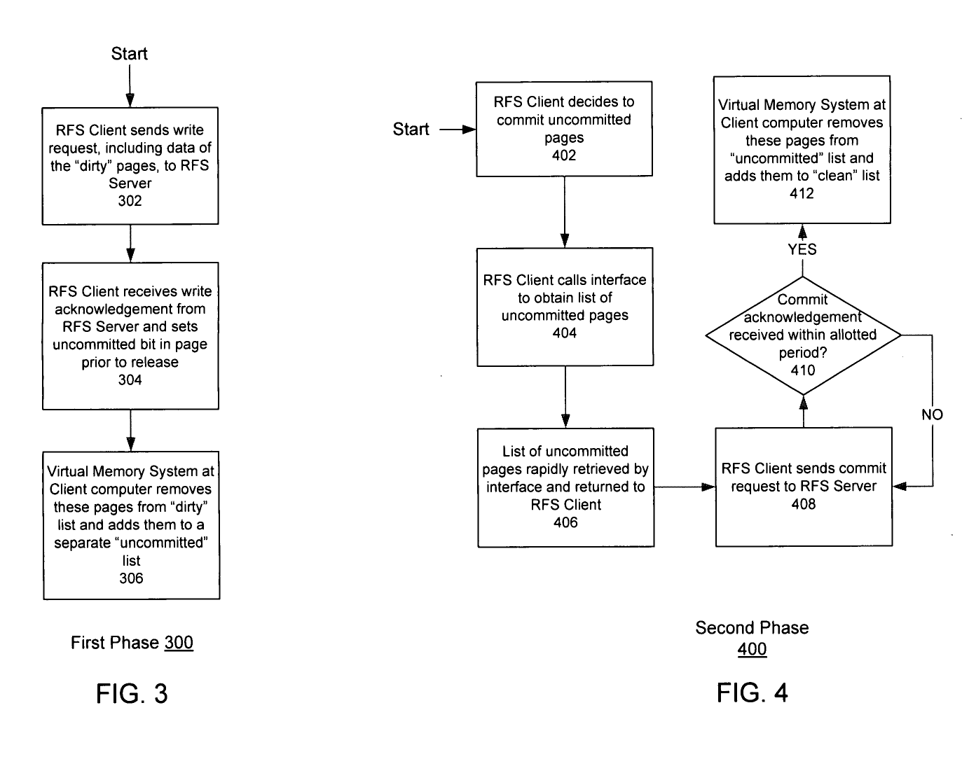

FIG. 3 is a flow chart depicting a first phase 300 in which “dirty” pages are written to the remote file system in accordance with an embodiment of the invention. A “dirty” page is a page of the remote file system which has been modified at a client 102 but has not yet been sent to the server 104 of the remote file system.

In a first step 302, the RFS Client 202 sends a write request, including the data of the “dirty” pages, over the network to the RFS Server 212. This write request is an asynchronous write request.

When the RFS Server 212 receives the write request, it writes the data to the file system 214 which stores the data in volatile memory 217 of the Server 104. Thereafter, the RFS Server 212 sends a write acknowledgement to the appropriate RFS Client 202. Periodically, the file system 214 writes data from the volatile memory 217 to the stable data storage 218 of the Server 104.

In a second step 304, the RFS Client 202 receives a write acknowledgement over the network from the RFS Server 212 and sets a bit in the page specifying that it is uncommitted before releasing the page. The write acknowledgement is typically received in a relatively short time because the write is asynchronous. If the write acknowledgement is not received within an allotted time, then the RFS Client 202 typically goes back to the first step 302 and re-sends the write request.

In a third step 306, after the page is released, the Virtual Memory System (VMS) 204 at the client computer 102 removes these pages from a “dirty” list 207 and adds them to a separate “uncommitted” list 208. The “dirty” and “uncommitted” lists are lists of pages of the remote file system. In addition, there is a “clean” list 209. These lists may be accessed (read and written) by the VMS 204 by way of an interface 206 at the client computer 102. The VMS 204 may determine that these pages are to be added to the “uncommitted” list 208 (instead of the “clean” list 209) because the aforementioned uncommitted bit is set.

FIG. 4 is a flow chart depicting a second phase 400 in which pages are committed to stable data storage 218 in accordance with an embodiment of the invention. As discussed above, the RFS Client 202 writes the “dirty” pages to the file system 214 in the first phase 300. This second phase 400 may be performed some time after the first phase 300. In this second phase 400, the pages are committed to the stable data storage 218.

In a first step 402, the RFS Client 202 makes a determination (“decides”) to commit uncommitted pages to stable data storage 218. In many instances, this determination to commit may occur a substantial time after the pages were written to the remote file system. For example, a large file may be sent by an RFS Client 202 to the remote file system via many write requests. Subsequently, the RFS Client 202 may determine to commit any uncommitted pages.

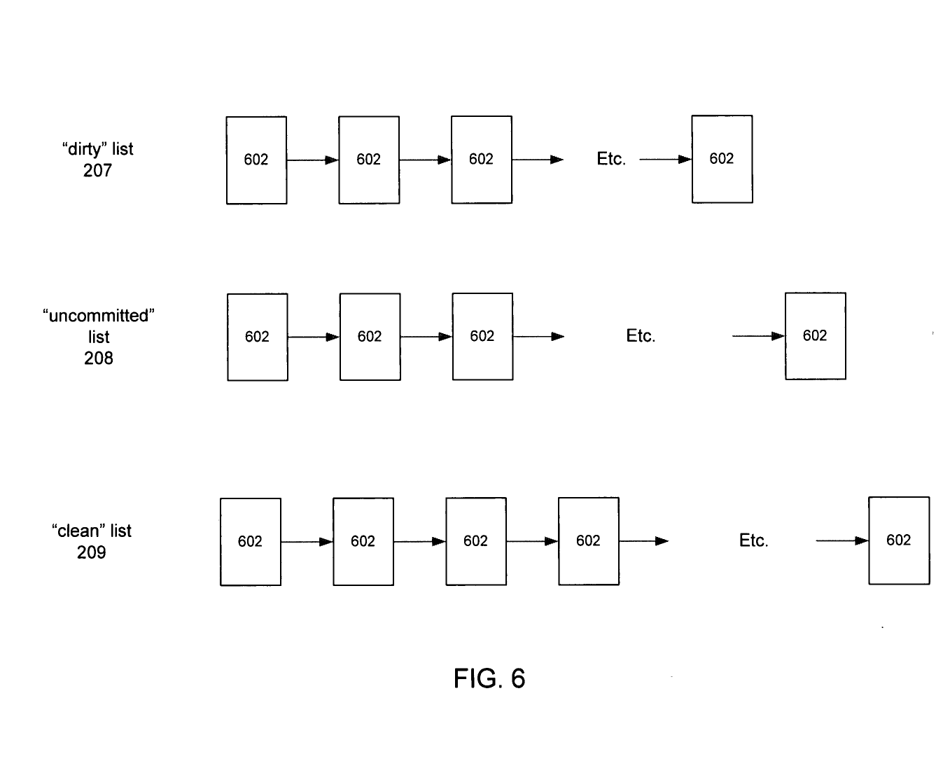

In a second step 404, the RFS Client 202 calls the interface 206 to access the “uncommitted” list 208 so as to obtain a list of all the uncommitted pages. Such a separate “uncommitted” list 208 does not appear to be built and maintained by conventional remote file system clients. In accordance with a preferred embodiment, the “uncommitted” list comprises a linked list of uncommitted pages. Advantages of using such a linked list data structure are discussed below in relation to FIG. 6.

In a third step 406, the list of uncommitted pages is rapidly retrieved by the interface 206 and returned to the RFS Client 202. This rapid retrieval is enabled by the maintenance of the separate “uncommitted” list 208 at the client computer 102.

In a fourth step 408, the RFS Client 202 then sends to the RFS Server 212 a request to commit the list of pages. All, some, or none of these pages may already be committed to the stable data storage 218. This is because uncommitted pages are periodically committed to the stable data storage 218 by the file system 214. The file system 214 works to commit those pages not yet committed to the stable data storage 218. When the entire list of pages has been committed, the RFS Server 212 returns a commit acknowledgement to the RFS Client 202.

Per the decision block 410, if a commit acknowledgement is received by the RFS Client 202 within the allotted time period, then, in a fifth step 412, the VMS 204 at the client computer 102 may use the interface 206 to remove the pages from the “uncommitted” list 208 and add them to the “clean” list 209. On the other hand, if no commit acknowledgement is received by the RFS Client 202 within the allotted time period, then the RFS Client may re-send the commit request.

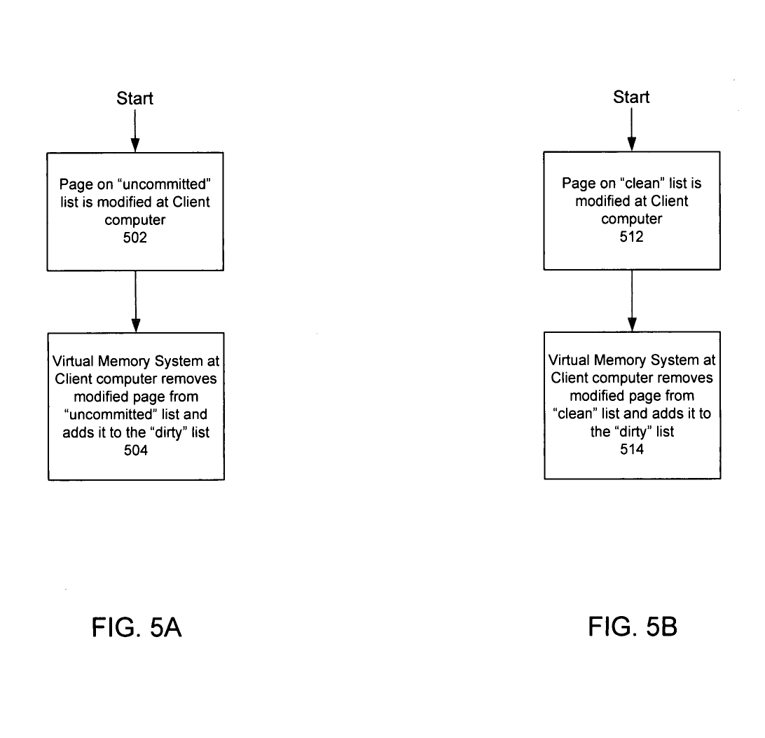

FIGS. 5A and 5B are flow charts depicting moving pages between lists after modification at a client computer 102 in accordance with an embodiment of the invention. Per FIG. 5A, when a page on the “uncommitted” list 208 is modified at the client computer 102 (step 502), then the VMS 204 at the client computer 102 uses the interface 206 to remove the modified page from the “uncommitted” list 208 and to add it to the “dirty” list 207 (step 504). Similarly, per FIG. 5B, when a page on the “clean” list 209 is modified at the client computer 102 (step 512), then the VMS 204 at the client computer 208 uses the interface 206 to remove the modified page from the “clean” list 209 and to add it to the “dirty” list 207 (step 514).

FIG. 6 is a schematic diagram depicting linked lists of pages in accordance with an embodiment of the invention. The size of a page corresponds to a minimum granularity of memory that is being used by the virtual memory system. The page size may be a tunable parameter. As shown in FIG. 6, each list (the “dirty” list 207, the “uncommitted” list 208, and the “clean” list 209) may be structured, for example, as a linked list. Each linked list includes a sequence of linked nodes 602, where each node 602 corresponds to different page.

In accordance with an embodiment of the invention, the linked lists are maintained in an unsorted order for higher performance. Nevertheless, the virtual memory system 204 may be configured to return either a sorted or an unsorted list to the RFS Client 202. For example, the VMS 204 may be configured such that the RFS Client 202 may request a contiguous range of pages. The VMS 204 may then retrieve a first page within that range, then retrieve pages before and after the first page so as to retrieve the range of pages.

Problems and Inefficiencies Overcome

When a client in a conventional remote file system wants to commit pages to stable data storage, the client has to scan a list of all clean pages. As the client scans the list of clean pages, it checks whether the page is committed or uncommitted. If the page is uncommitted, then the client builds a range of consecutive pages that are uncommitted. This range is sent to the server for the data to be committed to stable data storage.

Such a conventional technique has at least two problems. First, time is wasted scanning pages that have already been committed. For example, if a file has one thousand clean pages, but only one page is uncommitted, the conventional technique must still scan all the one thousand pages before determining that only one page needs to be committed. Second, the clean list may be unsorted and so the client may have to send many messages to the server.

The present application discloses a much more efficient technique for handling uncommitted pages in a remote file system. In accordance with an embodiment of the invention, at least three lists of pages are formed and maintained, including a “dirty” list, a “clean” list, and a separate “uncommitted” list. In accordance with an embodiment of the invention, these lists may be structured as linked lists having an unsorted order.

The technique disclosed herein has various advantages over the conventional technique. First, forming and maintaining a separate “uncommitted” list enables the client to quickly obtain ranges of uncommitted pages to be committed. Second, with the lists structured as linked lists, pages may be readily added or removed from the lists.

Hence, the technique disclosed herein provides a remote file system with a highly efficient way of handling uncommitted pages. In particular, this technique solves the problem of inefficient scanning for uncommitted pages which occurs in the conventional technique.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A computer apparatus comprising:
coded instructions stored in computer-readable memory and configured as a client of a remote file system;
a virtual memory system configured to be accessible by the client; and
three lists accessible by the client, including a list of dirty pages, a list of uncommitted pages, and a list of clean pages.

2. The computer apparatus of claim 1, wherein the list of uncommitted pages is structured as a linked list.

3. The computer apparatus of claim 1, wherein the three lists are structured as linked lists.

4. The computer apparatus of claim 1, wherein said coded instructions are further configured to (i) send a write request, including data of select dirty pages, to a server of the remote file system, (ii) receive a write acknowledgement from the server, and (iii) set an uncommitted bit in said pages prior to releasing said pages.

5. The computer apparatus of claim 1, wherein the virtual memory system is further configured to remove written but uncommitted pages from the list of dirty pages and to add said pages to the list of uncommitted pages.

6. The computer apparatus of claim 5, wherein the virtual memory system is further configured such that, (i) when a page on the list of uncommitted pages is modified, the page is removed from the list of uncommitted pages and added to the list of dirty pages, and (ii) when a page on the list of clean pages is modified, the page is removed from the list of clean pages and added to the list of dirty pages.

7. The computer apparatus of claim 1, wherein said coded instructions are further configured to call an interface to retrieve the list of uncommitted pages.

8. A method of handling uncommitted pages in a remote file system, the method comprising maintaining at least three lists at a client of the remote file system, said at least three lists including a list of dirty pages, a list of uncommitted pages, and a list of clean pages.

9. The method of claim 8, wherein the list of uncommitted pages is structured as a linked list.

10. The method of claim 8, wherein the three lists are structured as linked lists.

11. The method of claim 8 further comprising the client (i) sending a write request, including data of select dirty pages, to a server of the remote file system, (ii) receiving a write acknowledgement from the server, and (iii) setting an uncommitted bit in said pages prior to releasing said pages.

12. The method of claim 8 further comprising a virtual memory system removing written but uncommitted pages from the list of dirty pages and adding said pages to the list of uncommitted pages.

13. The method of claim 12 further comprising the virtual memory system removing a modified page from the list of uncommitted pages and adding the modified page to the list of dirty pages.

14. The method of claim 8 further comprising the client calling an interface to retrieve the list of uncommitted pages.

15. A remote file system comprising:
a server computer;
a client computer; and
a network communicatively interconnecting the server computer to the client computer,
wherein the client computer is configured to maintain at least three lists, said at least three lists including a list of dirty pages, a list of uncommitted pages, and a list of clean pages.

16. The remote file system of claim 15, wherein the list of uncommitted pages is structured as a linked list.

17. The remote file system of claim 15, wherein the three lists are structured as linked lists.

18. The remote file system of claim 15, wherein the client computer is further configured to (i) send a write request, including data of select dirty pages, to the server, (ii) receive a write acknowledgement from the server, and (iii) set an uncommitted bit in said pages prior to releasing said pages.

19. The remote file system of claim 15, wherein the client computer is further configured to remove written but uncommitted pages from the list of dirty pages and adding said pages to the list of uncommitted pages.

20. The remote file system of claim 19, wherein the client computer is further configured to remove a modified page from the list of uncommitted pages and add the modified page to the list of dirty pages.
